(19) United States
(12) Patent Application Publication
(10) Pub. No.: US 2002/0107729 A1
(43) Pub. Date: Aug. 8, 2002

(54) Method and system for timing promotions based on a prior receipt of promotions

(75) Inventor: Gary M. Katz, Northbrook, IL (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CATALINA MARKETING INTERNATIONAL, INC., St. Petersburg, FL

(21) Appl. No.: 09/776,714

(22) Filed: Feb. 6, 2001

(51) Int. Cl. G06F 17/60

(52) U.S. Cl. 705/14

(57) ABSTRACT

A method, system, and computer-readable medium for timing the provision of promotions based upon previously received promotions. Through the examination of the parameters of previously provided promotions, new promotions that are likely to be redeemed in high numbers and/or rates can be provided to the consumer. Example parameters of previously provided promotions include the timing, the industry, the valid dates, the valid locations, the packaging, and other factors that relate to the previously provided promotions.

### BACKGROUND OF THE INVENTION

1. Field of the Invention

This invention relates to a system for timing promotions. More specifically, this invention is directed toward timing the provision of promotions to consumers based upon the consumer's receipt of previously provided promotions.

2. Discussion of the Background

To date, the timing of the provision of promotions has largely been performed independently of the circumstances and/or behavior of the individual consumer (see, e.g., U.S. Pat. No. 5,502,636 to F. G. E. Clarke, the contents of which are incorporated herein by reference). For example, a mass marketer will provide a single promotion to multiple consumers substantially simultaneously, without regard for the suitability of the time of provision for the individual consumers. Although the timing of the provision of promotions may be chosen by a mass marketer to correspond with broad demographic and/or seasonal trends (such as, e.g., providing Christmas-related promotions in December, lawn-care good promotions in spring and fall), there is little or no effort to time the provision of promotions to the circumstances of the individual consumer's life.

As a result of the lack of targeted timing, consumers are often either inundated by promotions of marginal and/or identical relevance, or they are provided with too few promotions over a given time period. In either case, the net number and/or rate at which promotions are exercised drops. Thus, even when a promotion is selected with the demographic characteristics and/or purchase history of an individual consumer in mind, little or no thought is given to timing the provision of such promotions to the consumer's individual situation. For example, if a consumer frequently shops at a particular supermarket and receives a large number of targeted promotions during each visit, then the consumer may not be able to keep track of the large number of promotions or the consumer's perception of the value of the promotions may drop. A drop in the net exercise rate of promotions may thus occur. On the other hand, if a consumer only infrequently shops at a particular supermarket, then providing only a small number of promotions during each visit may result in promotions that would, if provided, be exercised remaining unexercised since they are never provided to the consumer. In this case, even though the rate of exercise might remain high, the total number of promotions exercised would remain quite low.

The lack of a timing mechanism for the provision of promotions also restricts the revenue generated by providers of promotions and/or the effectiveness of the provided promotions. For example, a providers of targeted promotions may have contracts to distribute eight targeted promotions to an individual consumer at a particular supermarket over a period of two months. If all eight promotions were provided during a single visit, then the likelihood that an individual consumer will, e.g., pay attention to and/or exercise the eight provided promotions is quite small. On the other hand, if the provider of promotions only distributes one promotion per visit and the consumer only visits the supermarket four times, than four promotions will go unprovided.

This deficiency is especially relevant to the providers of targeted promotions who receive their fee on either a “per distribution” and/or a “per hit” basis. For example, a provider of targeted promotions may only receive a fee when a targeted promotion is provided to a consumer (i.e., on a “per distribution” basis). In the exemplary case described above, if a provider of targeted promotions does not provide a large number of targeted promotions at each visit to an infrequent shopper, then potential revenue is lost since the unprovided promotions will never be provided. In the other exemplary case, if a provider of targeted promotions only receives a fee when a targeted promotion is exercised by a targeted consumer (i.e., on a “per hit” basis) and the provider inundates a consumer with an excessive number of promotions, then the exercise rate may drop and the provider's cost per exercised promotion may increase.

Moreover, the lack of a liming mechanism for the provision of promotions limits the “product range” marketed by providers of targeted promotions. For example, providers of targeted promotions cannot offer more than one class (related to timing) of targeted promotion provision services. For example, ten individual companies may wish to contract a targeted promotion provider to provide their promotions to a particular consumer demographic at a predetermined maximum number of promotions per visit to the supermarket. In the absence of any timing mechanism, promotions from the ten individual companies may be provided in a haphazard and/or arbitrary (e.g., alphabetically or according to who first returned the service contract) manner. As such, there is no mechanism for a provider of targeted promotions to sell “high” or “low” timing priority promotion provision services to consumers which would determine the order in which the promotions would be provided. In other words, the providers of targeted promotions only offer “one-size-fits-all” timing of the provision of promotions. As such, revenue that could be generated by offering high timing priority promotion provision services is lost, and low priority promotion provision services that may be desirable to, e.g., lower budget manufacturers or other low-budget promoters are not available.

### SUMMARY OF THE INVENTION

Accordingly, one object of this invention is to provide a novel method, system, and computer-readable medium for increasing the rate and/or number of exercised promotions.

Another object of this invention is to provide a novel method, system, and computer-readable medium for timing the provision promotions based upon characteristics of the promotions received by the individual consumer.

A further object of this invention is to provide, in one embodiment, a novel method, system, and computer-readable medium for producing new classes of promotion provision services.

Yet another object of this invention is to provide a novel method, system, and computer-readable medium for timing the provision promotions to ensure that a desired number of promotions is received within a particular time period.

These and other objects of the invention are realized by a novel method, system, and computer-readable medium that uses the characteristics of the promotions received by the individual, targeted consumer (including the desirability of the consumer to a promoter) to time the provision of promotions. Potential characteristics of the individual that can be used in conjunction with the characteristics of received promotions to time the provision of promotions include the consumer's characteristics such as, e.g., the frequency of purchases, the frequency of visits to a location, the frequency that a consumer exercises promotions, the demographic characteristics of the individual, the purchase history of the individual, the particular circumstances in the individual's life, the indicated tastes of the individual, and/or other characteristics that can be used to identify that the individual possesses certain trails. The desires of a promoter might also be used to time the provision of a promotion based upon promotions received, and these might be determined using factors such as the amount of money that a promoter might be willing to pay for a certain time and/or type of provision of promotion.

As used herein, the term “promotion” refers to any offer, advertisement, flier, newsletter, incentive, coupon, commercial, recipe, and/or communication for promoting one or more goods and/or services.

As used herein, to “exercise” a promotion refers to any redemption, consumption, employment, application, availment, weilding, exploitation, viewing, use, hearing, and/or reading of a promotion.

As used herein, a “promoter” is any company, manufacturer, distributer, retailer, wholesaler, service provider, individual, and/or any other entity that wishes to provide promotions related to the promoter's product and/or service to consumers.

As used herein, a “provider of promotions” is any company, manufacturer, distributer, retailer, wholesaler, service provider, individual, and/or any other entity that will provide promotions to consumers, or cause promotions to be delivered to consumers.

Although providers of promotions are discussed herein as being separate entities from promoters, this is not necessary to practice the present invention. For example, a single retailer can time the distribution of promotions by the retailer and related to the retailer's own product(s) using the present invention. Thus, the “promoter” and “provider of promotions” need not be separate entities.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 illustrates an exemplary network structure for timing the provision of promotions;

FIG. 2 illustrates a second exemplary network structure for timing the provision of promotions that can be used alone or in conjunction (in whole or in part) with the exemplary network structure of FIG. 1;

FIG. 3a and 3b illustrate two exemplary data records for storing promotion data and consumer identification data;

FIGS. 4a and 4b illustrate two exemplary data records for storing consumer characteristic data (including promotions received data) and consumer demographic data;

FIGS. 5 illustrates an exemplary data record for storing consumer purchase history data;

FIG. 6 is a flow chart that illustrates an exemplary method for timing the provision of promotions;

FIG. 7 is a flow chart that illustrates an exemplary method for timing the provision of promotions that relies upon the examination of certain factors to determine the timing of the provision of a promotion;

FIG. 8 is a flow chart that illustrates an exemplary method for timing the provision of promotions that includes updating the record of promotions provided;

FIG. 9 is a flow chart that illustrates a promotion-driven method for timing the provision of promotions;

FIG. 10 illustrates an exemplary computer system that can form several different units in an embodiment of the present invention.

### DETAILED DESCRIPTION OF THE PREFERRED EMBODIMENTS

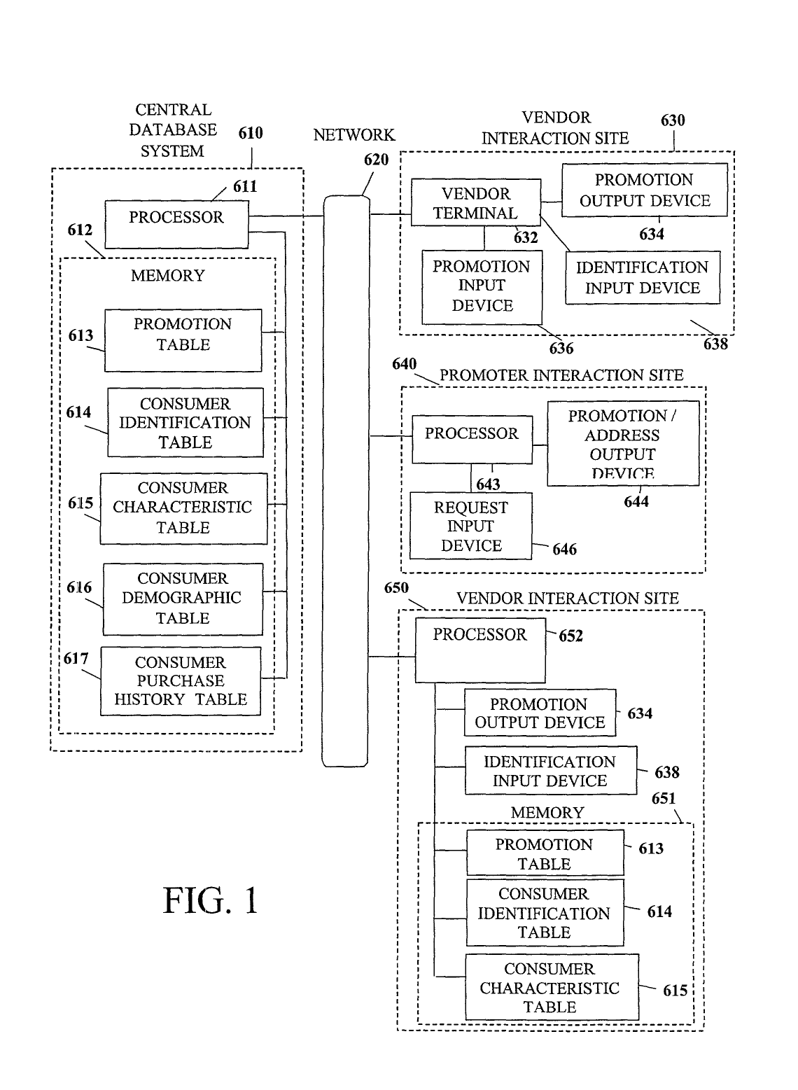

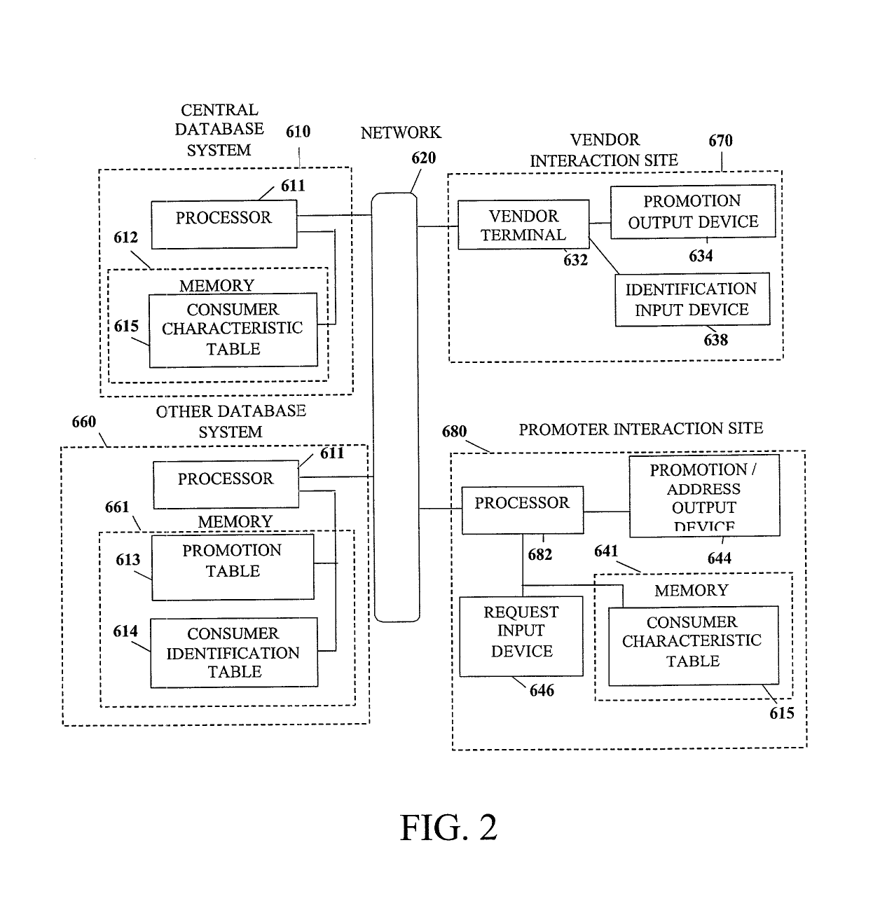

Referring now to the drawings, wherein like reference numerals designate identical or corresponding parts throughout the several views, and more particularly to FIGS. 1 and 2 thereof, which illustrate exemplary network structures for targeting promotions based upon a historical record of promotion usage. These network structures will include at least one vendor interaction site 630, 650, and/or 670 that is connected by way of a network 620 to a central database system 610, and other database system 660, and, possibly, one or more promoter interaction sites 640 and/or 680. In alternate embodiments, network 620 can be dispensed with in whole or in part, and the one or more vendor interaction sites and/or promoter interaction sites 630, 640, 650, 670, and/or 680 can include the some or all of the data and functionality herein attributed to the central database system 610. This is explicitly illustrated in vendor interaction site 650 of FIG. 1 which contains a promotion table 613, a consumer identification table 614, and a consumer characteristic table 615, as well as in promoter interaction site 680 of FIG. 2 which contains a consumer characteristic table 615. Thus, the network 620 can be implemented either as a communications or telecommunications network, or as an electrical lead, wire, or bus within a computer. As illustrated in FIG. 2, the central database system 610 of FIG. 1 can be divided into a plurality of database systems, such as central database system 610 and other database system 660 of FIG. 2, each directed to a subset of the data and functionality ascribed to the central database system 610 illustrated in FIG. 1. Furthermore, some embodiments of the network structure may include a vendor interaction site 650 which can redundantly combine some or all of the structures and/or functionality ascribed to central database system 610 with a vendor interaction site 630. As illustrated in FIGS. 1 and 2, the vendor interaction site 650 is connected to the central database system by way of network 620. This is not necessarily the case, and the vendor interaction site 650 can form a physically discrete unit that may or may not be connected to a network.

The processor 611 of central database system 610 is used for coding and decoding data transmitted over network 620, controlling reading and writing of data in tables 613, 614, 615, 616, and 617, and analyzing the data in tables 613, 614, 615, 616, and 617. The processor 611 (and processors 643, 652, and 682) can be any processor configured for high volume data transmission and performing a significant number of mathematical calculations in processing communications (possibly as a webserver), database searches, and computational algorithms. A conventional personal computer or workstation with sufficient memory and processing capability may be configured to act as processor 611. A PENTIUM III microprocessor such as the 1 GHz PENTIUM III for the SC 242 manufactured by Intel Inc., a Motorola 500 MHZ POWERPC G4 processor, and the Advanced Micro Devices 1 GHz AND ATHLON processor may all be used as the processor 611. The tables 613, 614, 615, 616, and 617 may reside or be stored on any suitable processor-accessible data medium, including but not limited to any type of disk including floppy disks, optical disks, CD-ROM, magneto-optical disks, ROMs, RAMs, EPROMs, EEPROMs, flash memory, magnetic or optical cards, or any type of media suitable for storing data.

The network 620 may be a local area network, a wide area network (such as the Internet), a virtual private network, and/or a connection via a public switched telephone network. In an exemplary embodiment, the network 620 includes a number of connection modalities, including a cable-modem connection, a DSL connection, a dial-up modem connection, and/or other suitable connection mechanisms.

The first vendor interaction site 630 includes a vendor terminal 632 that is located at, e.g., the check-out counter of a store, a vending machine, a central location shared by several stores, a mobile kiosk at a central location in a trade show, flea market, or street fair, an airline ticket counter, an entrance of a public accommodation such as a ballpark, nightclub, casino, or movie theater, a restaurant, a telephone where sales orders are placed, or even an individual's home computer in the case of Internet transactions. The vendor terminal 632 can include a processor similar to processor 611, but in an exemplary embodiment it is simply dedicated to the reception and transmission of data over network 620 and the coding and decoding of data received from promotion input device 638, ID input device 638, and output to promotion output device 630b.

Vendor interaction site 630 is designed to be operated by the vendor and/or the potential customer. When the vendor interaction site 630 is placed at a position where the vendor can control the operation of the device (e.g., check-out counter, entrance to club or theater, airline ticket counter), the vendor is the party primarily responsible for the maintenance of the site. However, in certain transactions, such as in the case of Internet transactions, the vendor interaction site 630 may be physically removed from the vendor and owned/operated by, e.g., a consumer. Thus, an individual consumer's home personal computer can form a vendor interaction site 630, even though the vendor is not responsible for the site. Some locations of the vendor interaction site 630, such as at a mobile kiosk at a flea market or trade show, may include having a 3^{rd} party be responsible for the vendor interaction site 630.

In some embodiments, vendor interaction site 630 can include a promotion input device 636 such as a keyboard, touch screen, computer mouse, bar code reader, magnetic reader (including strip, disk, and tape reader), smart card reader, pressure sensor, motion detector, electromagnetic receiver, voltmeter, heat sensor, and other transducer capable of receiving promotion identification information. One common example is a bar code reader that transduces barcodes oil coupons at a supermarket check-out counter. The promotion identification information will allow the vendor and/or maintainer of the central database system 610 to identify information about the promotion presented to the promotion input device 636 at the vendor terminal 630. This information can be the compared with previously stored information (not shown) located in, e.g., the central database system 610 so that the promotion presented to the promotion input device 636 may be identified, recorded, and/or analyzed.

The exemplary vendor interaction sites 630 also includes an identification input device 638 that receives identification information regarding a consumer. In the exemplary vendor interaction site 630, the received identification information is forwarded to the central database system 610 where processor 611 compares it with previously stored information found in consumer identification table 614 to provide a confirmed identification of the consumer. Identification input device 638 can be any of a number of devices that receive and/or transduce identifying information regarding a consumer. Examples of embodiments of identification input device 638 that transduce identifying information include keyboards, touch screens, computer mouses, bar code readers, magnetic readers (including strip, disk, and tape readers), smart card readers, pressure sensors, motion detectors, electromagnetic receivers, voltmeters, heat sensors, voice transduction devices (e.g., microphones), digital cameras, fingerprint readers, iris recognition devices, genetic identification devices, and other transducers capable of transducing identification information regarding an individual and transferring this information to a digital processor. Examples of embodiments of identification input device 638 that receive identifying information without performing a transduction of a physical parameter include processors configured to receive digitized signals, images, sounds, patterns, and/or other information and analog-to-digital converters configured to convert analog signals, images, sounds, patterns, and/or other information into a digital format. This, the identification input device 638 of the vendor interaction site 630 need not conduct the actual transduction of the identification information, but rather identification input device 638 must simply be capable of receiving identification input. This identifying information can be in the form of a digitized list of consumer's names. Another particular example of an identification input device 638 is a preferred customer card reader at a checkout counter in a supermarket.

Since the vendor interaction site 630 (including the identification input device 638) can be operated by a consumer and/or third party, the identification information can be a code or password provided by, e.g., a vendor for use by a particular customer. This can include, for example, a cookie placed on the consumer's home computer. The use of cookies in targeted marketing is described in, e.g., U.S. Pat. No. 6,055,573 to Gardenswartz et al., the contents of which are incorporated herein by reference. Regardless of the nature of the identifying information, it is used to “identify” the consumer.

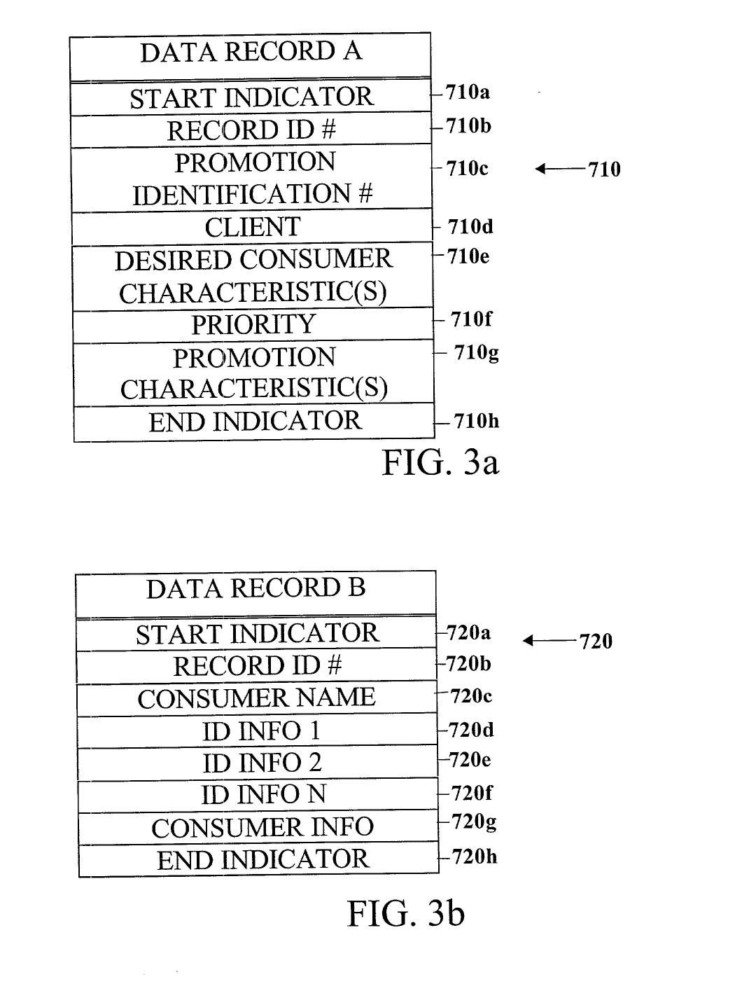

Regardless of the nature of identification input device 638, once identification data is transduced and/or received, it can be transferred from vendor terminal 632 to processor 611 of central database system 610. Naturally, this can be done by way of a network 620, or alternatively a processor similar to processor 611 can be part of vendor interaction site 630 (such as processor 652 shown in vendor interaction site 650). Regardless of its location, the processor 611 can compare the received identification information to previously stored identification information found in consumer identification table 614 to determine the identity of the consumer. An exemplary data record that could be found in identification table 614 is illustrated as Data Record B 720 of FIG. 3b. Once the identity of the consumer has been determined, it can be used, e.g., to add data records to the consumer characteristic table 615 or to identify relevant records found in the consumer demographic table 616 or the consumer purchase history table 617. All or some of these tables 615, 616, or 617 can be used determine an appropriate timing for the provision of promotions that are stored, e.g., in promotion table 613.

Adding a new record to the consumer characteristic table 615 can be done once the identity of the consumer and a characteristic of the consumer which has just been revealed is available to the processor 611. This record can include further information that has not been previously known but has just come to light (such as, e.g., the educational level of a consumer long finished with schooling) or information that has changed (such as a change in marital status, income level, recent promotions received, recent visits to a vendor, recent promotions exercised, etc.)

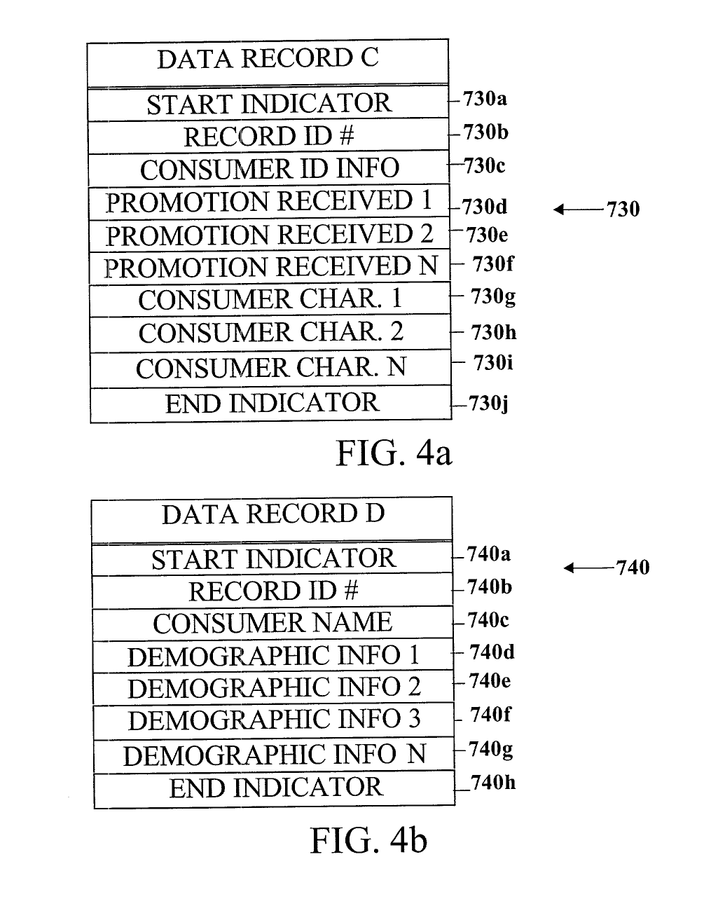

An exemplary data structure of a record included in consumer characteristic table 615 is illustrated in data record C 730 of FIG. 4a. Once processor 611 stores the information related to the characteristics (potentially including the receipt of one or more promotions) in consumer characteristic table 615, this information can accessed by processor 611 for analysis to determine a favorable timing for the provision of promotions.

In some embodiments, the identity of the consumer can be used to locate a relevant record in consumer demographic table 616. Consumer demographic table 616 can contain data regarding the demographics of the individual consumer such as, e.g., age, profession, gender, race, education level, marital status, number of children, pet ownership, and/or other demographic factors. An exemplary data structure of a record included in consumer demographic table 616 is illustrated in data record D 740 of FIG. 4b. Once processor 611 identifies the potential customer, the consumer's demographic information in consumer demographic table 616 can accessed by processor 611 to determine, in whole or in part, a favorable timing for the provision of promotions to the individual.

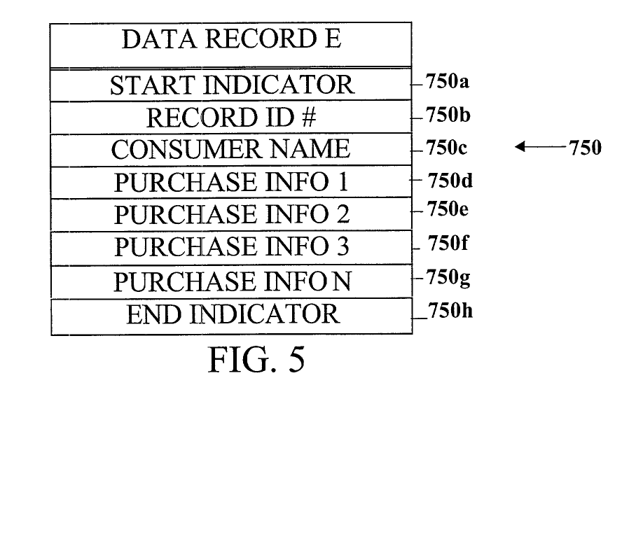

In some embodiments, the identity of the consumer can be used to locate a relevant record in consumer purchase history table 617. Consumer purchase history table 617 can contain data regarding the purchase history of the individual consumer such as, e.g., products previously purchased, the frequency of certain purchases, the name brands of certain purchases, the price of certain purchases (either in absolute terms or relevant to other available products), classes of products previously purchased, and locations where products are purchased. An exemplary data structure of a record included in consumer purchase history table 617 is illustrated in data record E 750 of FIG. 5. Once processor 611 identifies the potential customer, the consumer's purchase history in consumer purchase history table 617 can accessed by processor 611 to determine, in whole or in part, a favorable timing for the provision of promotions to the individual. Naturally, the consumer's demographic information in consumer demographic table 616 can be combined with the consumer's purchase history in consumer purchase history table 617 to more accurately identify a favorable timing for the provision of promotions.

Once again, one or more of the data tables 613, 614, 615, 616, and 617 need not be included in central database system 610, but can instead be located at a vendor interaction site 650 as illustrated in FIG. 1 or a promoter interaction site 680 of FIG. 2.

Information related to favorably timed promotion(s) and/or the determined favorable timing for the provision of promotions can be returned to vendor interaction sites 630, 650, and/or 670 by way of network 620 as desired, upon which one or more favorably timed promotions can be provided using, e.g., promotion output device 634. Promotion output device 634 can be any of a number of different devices, including a computer monitor, printers (paper or otherwise), magnetic writing devices (including disk drives, magnetic strip writers, tape writers), bar code writers, smart card writers, television screens, radio broadcast, Internet data transmission port, print advertisement in a newspaper or newsletter, or simply electronic confirmations communicated automatically to another device, such as, for example, a check-out register or a credit card billing machine. In one embodiment, the promotion output device 634 prints favorably timed coupons immediately after an identified consumer checks out at a supermarket cashier register.

Favorably timed promotions need not be directly provided to the consumer. This is illustrated explicitly by promoter interaction sites 640 and 680, which allow a promoter to independently provide consumer identification information without the presence of a consumer by way of a request input device 646. The promoter can provide consumer identification information that identifies a consumer directly, such as a consumer name, or indirectly, such a desired demographic and/or purchase history characteristic of the desired consumer. This identification information is transmitted by processor 642 or 682 through network 620 to central database system 610, where information relating to a favorable timing for the provision of promotions is determined and/or located, and returned to processor 642. Upon receipt of the information relating to a favorable timing for the provision of promotions at processor 642, this information can be used to output a favorably timed promotion (or an address of a consumer for which a promotion is favorably timed) at promotion/address output device 644. For example, if the consumer identification information input at request input device 646 was for an as-yet unidentified consumer with certain demographic, purchase history, and/or other characteristics, then promotion/address output device 644 can output an address label, email address, other consumer identification information, and/or item that insures that a promotion will be delivered to a suitable consumer. If the consumer identification information input at request input device 646 was for a particular consumer, then the demographic, purchase history, and/or other characteristics of that particular consumer can be examined in order to determine a timely provided promotion to be provided at promotion/address output device 644.

Request input device 646 can be a device such as a keyboard, touch screen, computer mouse, bar code reader, magnetic reader (including strip, disk, and tape reader), smart card reader, pressure sensor, motion detector, electromagnetic receiver, voltmeter, heat sensor, and other transducer capable of receiving request information. Promotion/address output device 644 can be any of a number of different devices, including a computer monitor, printers (paper or otherwise), magnetic waiting devices (including disk drives, magnetic strip writers, tape writers), bar code writers, smart card writers, television screens, radio broadcast, Internet data transmission, print advertisement in a newspaper or newsletter, or simply electronic confirmations communicated automatically to another device, such as, for example, a check-out register or a credit card billing machine. In one embodiment, request input device 646 is a computer keyboard operated by a promoter that wishes to provide promotions related to the promoter's product(s) and/or service(s), and promotion/address output device 644 is a address label printer used to provide a mailing address to timely provided promotions.

Vendor interaction site 650, in addition to containing both a promotion output device 634 and an identification input device 638, also contains a promotion table 613, a consumer identification table 614, and a consumer characteristic table 615. This type of interaction site can be operated alone or in conjunction with an central database system 610 as illustrated in FIGS. 1 or 2, or with an other database system 660 as illustrated in FIG. 2. For example, the promotion table 613 could be dedicated to promotions that are valid only at the store of the owner and/or operator of vendor interaction site 650, and the consumer identification table 614 could be dedicated to consumer identification information that is recognized only by the owner and/or operator of vendor interaction site 650. Moreover, the consumer characteristic table 615 could include information gathered at the store of the owner and/or operator of vendor interaction site 650, or relevant to the store of the owner and/or operator of vendor interaction site 650. For example, if the owner and/or operator of vendor interaction site 650 provides a certain discount at regular intervals (say, one time per month) to preferred customers, then the consumer characteristic table 615 of vendor interaction site 650 could be dedicated to the particulars regarding the provision and/or exercise of those promotions. As another example, if vendor interaction site 650 were owned and/or operated by a supermarket, “in-store” coupon identification information could be stored at promotion identification table 613 of vendor interaction site 650, identification information relevant to that supermarket's (or supermarket chain's) frequent customer cards could be stored at consumer identification table 614 of vendor interaction site 650, and information related to characteristics of the consumer such as the in-store promotions previously received by the consumer could be stored in consumer characteristic table 615 of vendor interaction site 650. However, if the consumer presented, e.g., a manufacturer's coupon or other identifying information such as a credit card, then vendor terminal 652 could access promotion identification table 613 and consumer identification table 614 central database system 610 to identify a promotion and/or consumer. Vendor interaction site 650 can also include a promotion output device (not shown), as discussed in regard to vendor interaction site 630.

Turning now specifically to FIG. 2, which shows further exemplary components of a network strructure according to the present invention, these elements being used alone or in conjunction with the network structure shown in FIG. 1, the central database system 610 of FIG. 2 has been pared down to a consumer characteristics table 615. In this case, some or all of the functionality, previously ascribed to the central database system 610 of FIG. 1 can be transferred in whole or in part to one or more components. For example, the other database system 660 now contains promotion table 613 and consumer identification table 614. The other database system 660 can be owned and/or operated by, e.g., a third party and/or a the promoter him or herself. In this way, a promoter can use consumer characteristic information from table 615 of central database system 610 that is gathered by other parties and/or originates outside the promoter's industry in order to time the provision of promotions.

Also illustrated in FIG. 2 is a vendor identification site 670 that does not include a promotion input device 636. The lack of a promotion input device 636 is intended to explicitly illustrate that no promotion need be exercised in order for a provider of promotions to perform the invention. Any time that a consumer is identified using identification input device 638, one or more targeted promotions can be output at promotion output device 634. This embodiment of vendor identification site 630 is particularly useful for small vendors that manually enter promotions, for vendors where promotions are not common and/or accepted (such as, e.g., physician's offices, legal offices, etc.), or when the vendor interaction site 630 is not used to conduct an actual purchase transaction, such as a vendor interaction site 630 that is formed by an individual's home computer.

Promoter interaction site 680 of FIG. 2 includes a consumer characteristic table 615 such as found at the central database system 610 of FIG. 1. The consumer characteristic table 615 at vendor interaction site 640 allows a promoter to record and store consumer characteristic data that are relevant to, e.g., the promoter's own products, stores, and/or services. Thus, data drawn from, e.g., a consumer demographic table 616, and/or consumer purchase history table 617 can be transmitted over network 640 in response to a request from the processor 682 of promoter interaction site 680 and analyzed at the same processor 682 in conjunction with consumer characteristic data from consumer characteristic table 615.

FIGS. 3a, 3b, 4a, 4b, and 5 all illustrate records that can serve as exemplary data structures for performing the present invention. Any suitable data structure and/or data storage technique may be used in accordance with the present invention. FIGS. 3a and 3b illustrate two different data record structures 710 and 720 that may be used in promotion table 613 and consumer identification table 614 of FIGS. 1 and 2. Promotion identification number 710c of promotion record 710 can be used to identify the particular promotion during, e.g., communications with a client promoter (such as in a billing statement) or to promotion output device 634 or promotion/address output device 644. The client field 710d, which identifies the client who is responsible for the promotion identified by promotion identification number 710c, is used to, e.g., identify the client for billing purposes and/or indicate upon a promotion output at promotion output device 634 who is responsible for the promotion. For example, if the promotion is an “in-store” coupon, the client field 710d would identify the relevant store to both the provider of promotions and the consumer receiving the promotion. The desired consumer characteristic field 710e stores information related to characteristics of the consumer that the promoter wishes to target. For example, the information stored in characteristic field 710e might describe a desired consumer demographic and/or purchase history record that the client identified in field 710d wishes to particularly target. The information stored in characteristic field 710e might also be used to describe a desired characteristic related to promotions received. For example, a promoter may wish to time the provision of promotions to a consumer based upon the last tie that a consumer has received a similar promotion, in order to optimize the attention provided by the consumer to the promotion. The priority field 710f is another field that can be used to favorably time the provision of promotions based upon promotions received. The priority field 710f can be used to by the client identified in field 710d to identify the priority of the timing of the provision of the promotion, and guarantee that the promotion will be provided under certain guidelines relative to promotions already received by the consumer. For example, a high priority promotion might only be provided after the consumer has not received a promotion for several days. As mentioned earlier, by providing promotions at different priorities, the provider of promotions now has a further product (e.g., high, medium, and low priority provision) that can be marketed to promoters. Furthermore, this will allow promoters to provide the same promotion (identified in field 710c) at different priorities (identified in field 710c) to consumers with different characteristics (identified in field 710e), presumably at different costs to the promoter. The promotion characteristic(s) field 710g identifies one or more characteristics of the promotion. These characteristics, can include, e.g., the value of the promotion either in absolute (e.g., a one dollar off coupon) or relative (e.g., a 10% off coupon) terms, the valid dates for exercise of the promotion, the valid locations for exercise of the promotion, the valid products for exercise of the promotion, a bar code pattern and/or other identifying information to be printed upon the promotion, and/or any other information related to the characteristics of the promotion.

Consumer identification record 720 is used to identify a consumer using information input at, e.g., identification input device 638. One or more identification factors input at an identification input device 638 can be compared to identification factor records 720d, 720e, and 720f to determine or confirm the identity of the individual identified in consumer name field 720c. When identity is being confirmed, the relevant consumer identification record 720 is first located using consumer name field 720c, but when identity is being determined, the relevant consumer identification record 720 is first located using identification factor records 720d, 720e, and 720f to locate a match or a near match. Regardless of whether a confirmation or determination is performed, after it has been completed, a consumer will be identified. Consumer information field 720g is optional and may include information related to the consumer such as, e.g., the address of the consumer, the memory location of further demographic, consumer purchase history, and/or characteristic information related to the consumer or even the demographic, consumer purchase history, and/or characteristic information itself.

FIGS. 4a and 4b illustrate two different data record structures 730 and 740 that may be used to store data regarding characteristics of the consumer in consumer characteristic table 615 and data regarding a particular consumer's demographic information in consumer demographic tables 616 of FIGS. 1 and 2. Consumer characteristic record 730 is used to store information related to the characteristics of the consumer. The consumer's name and/or other identifying information is stored in field 730c, and records of promotions received are stored in fields 730d, 730e, and 730f. Promotions received are one example of a type of consumer characteristic information that are particularly useful in determining the timing of the provision of promotions. As an example, if the provider of promotions has contracts to provide, e.g., ten promotions over the next month to a consumer with certain demographic characteristics, then the timing (e.g., the order) of the provision of these promotions can be based upon the timing (e.g., order) of the previously provided promotions. The timing (e.g., the order) of provision of the promotions can also be determined based upon, e.g., the nature, the value, the industry, the products, the locations of the new promotions relative to promotions received, and/or other factors related to promotions already received by the consumer. For example, if a consumer who is loyal to a first product recently received a promotion for a second product in the same class, then the promoter of the first product can request a high priority distribution of a promotion related to the first product. As another example, if a consumer recently started receiving a large number of baby-good product promotions, it might be expedient to provide yet another baby-good product promotion even in the absence of demographic and/or purchase history information that indicates that the consumer has a baby. As another example, if a consumer recently received a high value promotion for a product, then another promotion of lower value for the same product might not be particularly attractive to the consumer, and provision of such a promotion is delayed. As another example, if the consumer has recently been inundated by promotions from a particular industry, then yet another promotion from that same industry might also not be particularly attractive. As another example, if a consumer has recently received a promotion that requires the consumer to travel to a particular geographical location (e.g., a particular shopping center), then another promotion that also requires travel to the same geographical location might be particularly effective, and should be provided immediately to the consumer.

Consumer characteristic record 730 also includes other consumer characteristics in fields 730g, 730h, and 730i. These other consumer characteristics can include some or all of the demographic and/or purchase history information described in data records 740 and 750 (discussed below). However, these other consumer characteristics may also include demographic descriptors of promotions received, trends in promotions received, and/or other generalized information that is drawn from and/or based upon the individual records of promotions received described in fields 730d, 730e, and 730f. Naturally, both sets of fields 730g, 730h, and 730i and fields 730d, 730e, and 730f need not be stored or even used to perform the present invention. Rather, they are shown here in a single record to indicate that both relatively raw (fields 730d, 730e, and 730f) and relatively processed (fields 730g, 730h, and 730i) data may be used to perform the present invention. An example consumer characteristic stored in fields 730d, 730e, and 730f may be how often the consumer receives promotions. Other examples include the descriptors of the average value of received promotions, the average nature, and the types of locations where promotions are received.

Consumer demographic record 740 of FIG. 4b is used to store information related to the demographics of a consumer. The consumer's name is stored in field 740c and various demographic information is stored in fields 740d, 740e, 740f, and 740g. This demographic information can relate to, e.g., a consumer's age, profession, gender, race, education level, marital status, number of children, pet ownership, and other demographic factors.

FIG. 5 illustrates a data record structure 750 that may be used to store data regarding a consumer's purchase history in purchase history table 616 of FIG. 1. Consumer purchase history 750 is used to store information related to past purchases by the consumer, regardless of promotion usage. The consumer's name is stored in field 750c, and purchase information such as a product purchased, product price, date of purchase, location of purchase, and/or other purchase history information is stored in fields 750d, 750e, 750f, and 750g.

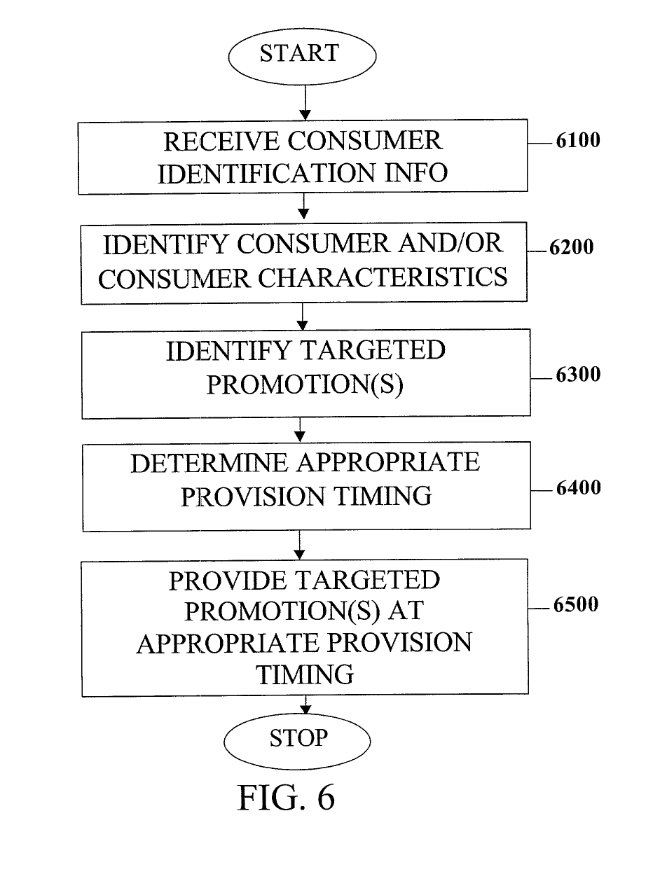

FIG. 6 is a flow chart that illustrates an exemplary method for timing the provision of promotions. This method is denoted as “consumer-driven” since the nature of the consumer drives the selection of promotions. This is particularly relevant in industries where the nature of the consumer is quite vital due to, e.g., the instantaneous presence of a consumer at a particular location, a limited number of consumers in a geographic location, particular consumer(s) having particular demographic characteristics, the desirability of a certain consumer demographic, and/or other reasons that a practitioner of predictive targeting might want to obtain a certain consumer(s). For example, a consumer may be instantaneously present at the checkout cashier of a supermarket. As another example, a SAAB dealer in a rural community might only have a limited number of potential SAAB consumers within that rural community and might need to target those individuals directly. As a yet further example, a magazine may desire a certain reader demographic so that it can charge certain fees to advertisers. Thus, by targeting consumers within the appropriate demographic group, the magazine may be able to increase its readership within the targeted demographic group.

In step 6100, consumer identification information is received. This can include scanning a preferred customer card at a supermarket cashier, receiving a list of desired consumers from a third party, or accessing consumer records to identify desired consumers. Consumer identification information can thus be received from an identification input device 638 as shown in FIGS. 1 and 2.

In step 6200, the received consumer identification information is used to identify the characteristics of the consumer. When the received consumer identification information already includes a name (or other unique identifier that can be used, e.g., to access records in consumer demographic table 616, consumer characteristic table 615, and/or consumer purchase history table 617) of the consumer, no further identification is necessary. On the other hand, when the received consumer identification information is a password, a scan reading from a smart card reader, and/or other data that cannot necessarily be used to access the records in consumer demographic table 616, consumer characteristic table 615, and/or consumer purchase history table 617, then the relationship between the received identification information and an identifier that can be used to access these records must be established. In either case, after step 6200, the received information can be used to identify certain characteristics of the consumer (such as those found in consumer demographic table 616, consumer characteristic table 615, and/or consumer purchase history table 617) that can be used to perform steps 6300 and 6400.

In step 6300, a promotion targeted to the identified consumer is identified. Ideally, the targeted promotion will be selected with the characteristics of the consumer in mind to increase the likelihood that the promotion is exercised. A more complete description of how this can be done is provided in, e.g., “The Direct Marketing Handbook,” Edward L. Nash, ed., McGraw-Hill, New York, 1992, the entire contents of which are incorporated herein by reference, and in U.S. Pat. Nos. 6,026,370, 5,974,399, 5,892,827, 5,832,457, 5,612,868, 5,173,851, 4,910,672, 6,014,634, 6,055,573 the entire contents of all of which are incorporated herein by reference. As mentioned above, in some cases there may be more than one targeted promotions identified. For example, if a consumer with particularly desirable demographic and/or purchase history characteristics is present at a check-out cashier of a supermarket, then a provider of promotions may have more than one promoter who wishes to provide such a consumer with promotions. As such, more than one promotions would be identified in step 6300.

In step 6400, an appropriate timing of the provision(s) identified in step 6300 is determined. As mentioned before, this is done in light of promotions already received by the identified consumer (or associated household members), as well as any of a number of different factors, including the demographic, purchase history, and/or other characteristics of the identified consumer, and/or priorities assigned by the promoters to the provision of certain promotions. Any characteristic of the promotions already received can be used to determine the appropriate timing of the provision(s) identified in step 6300. Such characteristics include the nature of promotions already received, the type of promotions already received, the class of promotions already received, the industry of promotions already received, the valid dates of promotions already received, the valid locations of promotions already received, this provision method of promotions already received, the packaging of promotions already received, other products that must be purchased to exercise the promotions already received, the value of promotions already received, the and/or the timing of promotions already received. As an example, if the provider of promotions has contracts to provide, e.g., ten promotions over the next month to a consumer with certain demographic characteristics, then the timing (e.g., the order) of the provision of these promotions can be based upon the timing (e.g., order) of the previously provided promotions. As another example, if a consumer has recently received a number of products for a certain industry (say, the personal care products industry), then the promoter of a personal care product may wish to delay the provision of another promotion. As another example, if the consumer recently received a promotion for a consumable good that had not yet expired, then it might be wise to delay the provision (and hence valid dates) of a promotion, especially since a consumer might not be able to consume the large amounts of a single product that would be purchased with the exercise of both promotions within the validity dates. As another example, if a consumer recently received a promotion by mail, then it might be highly desirable to present another promotion as soon as possible by another medium, such as by a targeted web advertisement. As yet another example, if a promotion already received by a consumer were packaged to provide the consumer with a certain association, then it might be wise to delay the provision of another promotions that was packaged to provide the consumer with a different association. For example, if a consumer had received a promotion for a Ford truck that was packaged to provide the consumer with the association of rugged individualism, then a second promotion for a Ford minivan packaged to provide the consumer with the association of family safety might be delayed (perhaps indefinitely).

In step 6500, a promotion(s) is provided to the identified consumer at the appropriate timing determined in step 6400. This can be done, e.g., using a promotion output device 634 described in FIGS. 1 and 2. Naturally, step 6500 need not be performed by the same entity that performs steps 6400. Rather, only information determined in step 6400 need be provided to the performer of step 6500. The promotions provided in step 6500 can include no promotions.

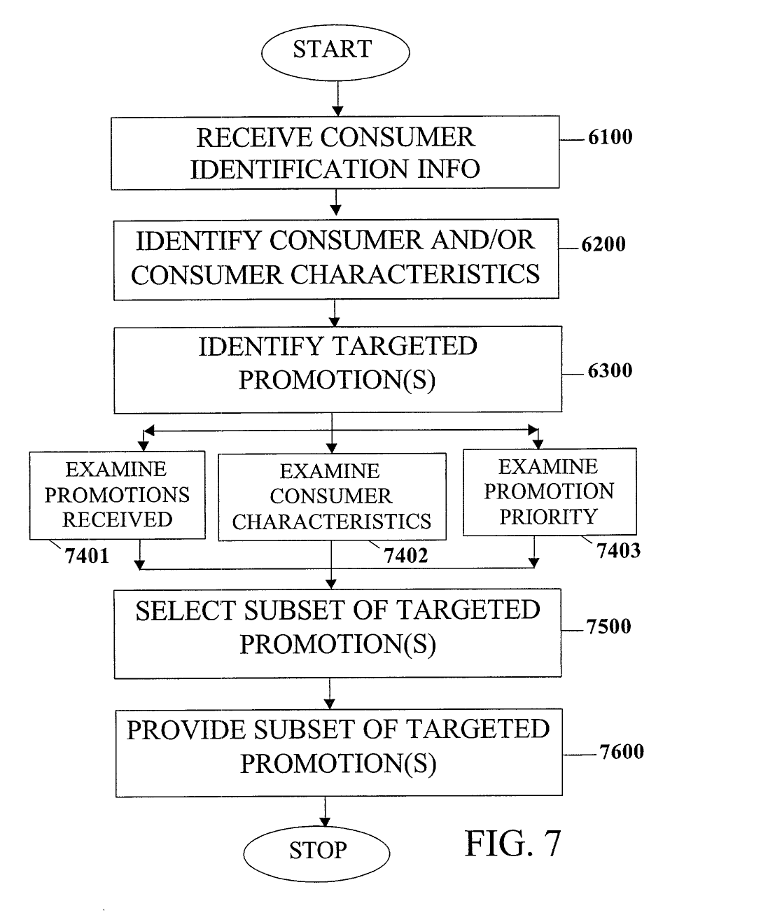

FIG. 7 is a flow chart that illustrates an exemplary method for timing the provision of promotions that relies upon the examination of certain factors including those related to promotions received to determine the timing of the provision of a promotion. The examination of factors illustrated in steps 7401, 7402, and 7403 can be performed either alone or together, to determine an appropriate timing for the provision of promotions, as described in regard to step 6400 of FIG. 6.

The examination of individual promotions received in step 7401 can be used to determine an appropriate timing for the provision of new promotions. For example, if a promotion for a certain product was received by a consumer a short time ago (e.g., two days, as determined from a data record 730), then it may be desirable to delay the provision of a new promotion for the same product, lest the consumer begin to assume that promotions for that product will always be available and start disregarding the individual promotions. On the other hand, for example, if a promoter is able to identify that the consumer has recently received a promotion from one of the promoter's competitors, then the promoter can issue a more desirable (e.g., higher value) promotion to the same consumer immediately. The promotions received by a consumer can be described by any of a number of different factors, including, e.g., the products, the sites, the times, related products, the industries, and the values for which they are valid. The description of these received promotions can thus be analyzed, and used to determine a timing for the provision of new promotions. The process described in step 7401 is particularly favorable since a provider of promotions can perform the invention using records of promotions provided that are desirable and collected for other reasons, such as billing clients and monitoring exercise rates. As such, the provider of promotions is making use of all available data without incurring new costs in memory and equipment for gathering and recording further data.

The examination of consumer characteristics in step 7402 can also be used to determine an appropriate timing for the provision of new promotions. These characteristics can included demographic and/or purchase history information, as well as broad descriptors related to promotions received. For example, if a particular consumer is geographically desirable to a promoter, then it may be advantageous to provide this particular consumer with promotions more often than other consumers are provided with promotions. In this case, a processor such as processor 652 or 643 could first determine the relative desirability of a consumer (based, for example, upon the location of a consumer's residence stored in field 720g of data record 720), and then use a record of promotions received (stored, for example, in table 615 of FIGS. 1 or 2) to determine if an appropriate time for the provision of a new promotion has been reached. The process described in step 7402 is particularly favorable since a wide range of consumer characteristics can be used to determine the timing of promotions.

The examination of promoter-input promotion priority in step 7403 can also be used to determine an appropriate timing for the provision of new promotions and can include a consideration of promotions received. Once again, these characteristics can included demographic and/or purchase history information, as well as broad descriptors related to promotions received. For example, if a particular consumer is demographically desirable to a promoter, then it may be advantageous to provide this particular consumer with promotions more often than other consumers are provided with promotions. In this case, a processor such as processor 652 or 643 could first determine the relative desirability of a consumer (based, for example, upon a priority of the consumer's demographic group 710e stored in field 710f of data record 710), and then use a record of promotions received (stored, for example, in table 615 of FIGS. 1 or 2) to determine if an appropriate time for the provision of a new promotion has been reached. The process described in step 7403 is particularly favorable since the designation of the priority originates from the promoter, rather than from the provider of promotions.

Steps 7401, 7402, and 7403 can be performed in whole or in part simultaneously. Naturally, they can be combined into a single examination, or they can be used in series to provide different levels of screening that become increasingly refined and the process flow proceeds.

Step 7500 involves selecting a subset of the targeted promotions identified in step 6300, the provision of this subset being favorably timed at the current time. Thereafter, this subset is provided to the consumer in step 7600. Naturally, the subset of promotions can include no promotions.

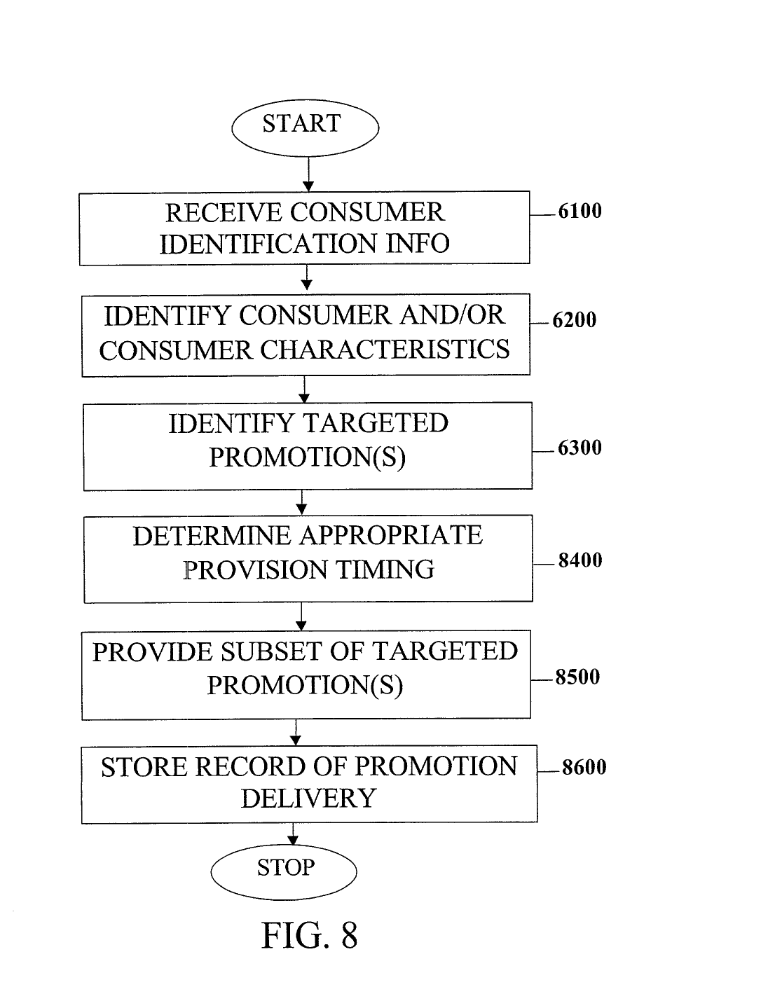

FIG. 8 is a flow chart that illustrates an exemplary method for timing the provision of promotions that explicitly includes updating the record of promotions provided in step 8600. Updating the records of promotions provided can be done for any of a number of different reasons, including billing clients and monitoring the effectiveness of the promotions (e.g., the exercise rates). Nevertheless, it is also necessary to perform step 8600 in order to keep data records 730 (which are used to perform the present invention) up to date. The promotions provided in step 8500 can be used to update the raw individual records of fields 730d, 730e, and/or 730f, or to update the processed individual records of fields 730g, 730h, and/or 730i (in combination with other raw data).

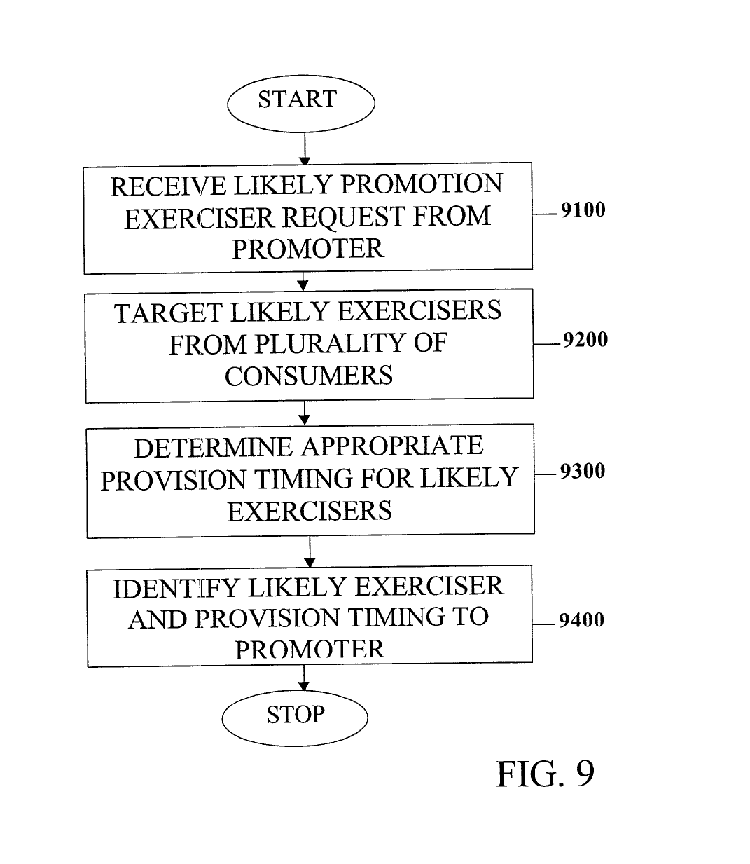

FIG. 9 is a flow chart that illustrates a promotion-driven method for timing the provision of promotions. This method is denoted as “promotion-driven” since the nature of the promotion drives the selection of consumers. This is particularly relevant in industries where the nature of promotions is quite limited due to, e.g., nature of the products, low profit margins, frequency of purchases by consumers, and/or historical promotions within an industry. For example, a durable-goods retailer might not be able to offer a “buy one, get one free” promotion, whereas a free service warranty would be useless for consumable and/or disposable goods.

In step 9100, a request for the identification of consumers who are likely to exercise a given promotion is made by a promoter and received by a provider of promotions. The given promotion can be identified by, e.g., the desired consumer characteristics such as those stored in field 710e of data record 710 or simply the promotion characteristics such as those stored in field 710g of data record 710. These characteristics can include, e.g., the relative value of the promotion, the absolute value of the promotion, the time allowed for exercise of the promotion, other purchases necessary to exercise the promotion, locations where the promotion can be exercised, the method by which the promotion will be delivered to the consumer, the language, color, and/or other packaging of the promotion, and/or any other characteristics of the promotion.

In step 9200, one or more consumers who are likely to exercise such a promotion are targeted. This can be done, e.g., by comparing the desired consumer characteristics such as those stored in field 710e of data record 710 with the actual demographic characteristics of several potential consumers stored in a plurality of demographic information records 740 in a consumer demographic table 616. The information used to identify one or more consumers who are likely to exercise such a promotion need not originate from the promoter, but it can also be extracted from the promotion itself. For example, the product promoted by the promotion can be compared with purchase history information such as that stored in table 617 of central database system 610 of FIG. 1.

In step 9300, an appropriate provision timing for the likely exercisers targeted in step 9200 is determined, based upon promotions received by the likely exercisers. This can be done in light of any of a number of different factors relating to promotions received, as previously described, including the individual promotions already received by the identified consumer (or associated household members), the demographic, purchase history, and/or other characteristics of the identified consumer, and/or priorities assigned by the promoters to the provision of certain promotions. This, each of the examinations described in steps 7401, 7402, and/or 7403 of FIG. 7 can be performed alone or together to perform the determination of step 9300.

In step 9400, the likely exercisers targeted in step 9200 and the provision timing for the likely exercisers determined in step 9300 is provided to the promoter. This information can include, e.g., a list of addresses of consumers and times for mailing promotions to the consumers at the listed addresses. Alternatively, favorably timed promotions can be directly provided to the likely exercisers using, e.g., promotion/address output device 644 of promoter interaction site 640.

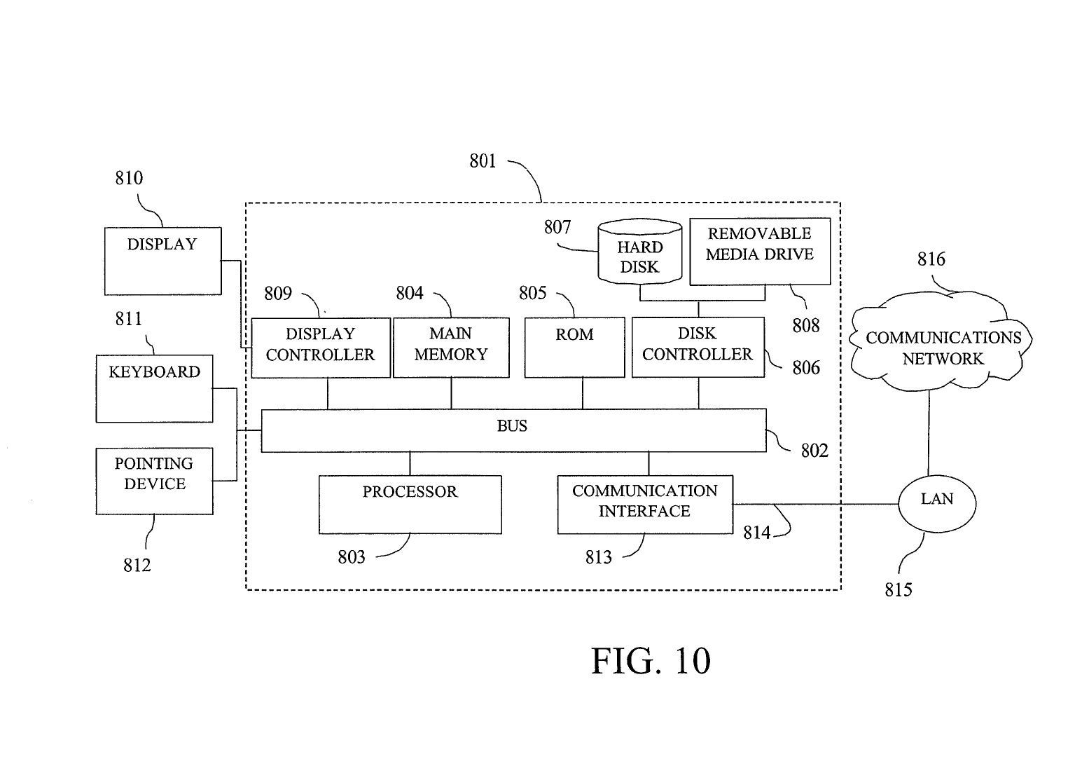

FIG. 10 illustrates a computer system 801 that can form several different units in an embodiment of the present invention. For example, computer system 801 can alternately form the central database system 610, a vendor interaction site 630, 650, or 670, a promoter interaction site 640 or 680, or an other database system 660 of FIGS. 1 and 2. For this reason, the computer system 801 will be described using unique reference numerals. When a part of computer system 801 that is analogous to a part in another figure is described, this will be stated in the text. Computer system 801 includes a bus 802 or other communication mechanism for communicating information, and a processor 803 coupled with bus 802 for processing the information. Processor 803 can form processor 611, 643, 652, 682 and/or the vendor terminal 632 of FIGS. 1 and 2. Computer system 801 also includes a main memory 804, such as a random access memory (RAM) or other dynamic storage device (e.g., dynamic RAM (DRAM), static RAM (SRAM), synchronous DRAM (SDRAM), flash RAM), coupled to bus 802 for storing information and instructions to be executed by processor 803. In addition, main memory 804 may be used for storing temporary variables or other intermediate information during execution of instructions to be executed by processor 803. Computer system 801 further includes a read only memory (ROM) 805 or other static storage device (e.g., programmable ROM (PROM), erasable PROM (EPROM), and electrically erasable PROM (EEPROM)) coupled to bus 802 for storing static information and instructions for processor 803. A hard disk 807 and/or removable media drive 808, such as a magnetic disk or optical disk, is provided and coupled to bus 802 by way of a disk controller 806 for storing information and instructions. Hard disk 807 and/or removable media drive 808 can contain the tables 613, 614, 615, 616, and 617 of FIGS. 1 and 2.

The computer system 801 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or further fixed, high density media drives, may be added to the computer system 801 using an appropriate device bus (e.g., a small computer system interface (SCSI) bus, an enhanced integrated device electronics (IDE) bus, or an ultra-direct memory access (DMA) bus). Such removable media devices and fixed, high density media drives can also contain the tables 613, 614, 615, 616, and 617 of FIGS. 1 and 2. The computer system 801 may additionally include a compact disc reader, a compact disc reader-writer unit, or a compact disc juke box, each of which may be connected to the same device bus or another device bus.

Computer system 801 may be coupled via bus 802 to a display 810, such as a cathode ray tube (CRT), for displaying information to a computer user. Display 810 can form a promotion and/or address output device 634 or 644 of FIGS. 1 and 2, especially when the vendor site is an individual's home computer and the promotion is an advertisement. The display 810 may be controlled by a display or graphics card. The computer system includes input devices, such as a keyboard 811 and a pointing device 812 (e.g., a cursor control), for communicating information and command selections to processor 803. The keyboard 811 and a pointing device 812 (e.g., a cursor control) can form a promotion, identification, and/or request input device 636, 638, and/or 646 of FIGS. 1 and 2. The pointing device 812 (e.g., cursor control), for example, is a mouse, a trackball, or cursor direction keys for communicating direction information and command selections to processor 803 and for controlling cursor movement on the display 810. In addition, a printer (not shown) may provide a promotion and/or promotion/address output device 634 or 644 of FIGS. 1 and 2, especially wherein the promotion is a coupon at the cashier of a supermarket.

The computer system 801 performs a portion or all of the processing steps of the invention in response to processor 803 executing one or more sequences of one or more instructions contained in a memory, such as the main hard disk memory 807. Such instructions may be read into the main hard disk memory 807 from another computer readable medium, such as removable media drive 808. Thus, either the main hard disk memory 807 or the removable media drive 808 can include instructions for performing the methods described in FIGS. 6-9. One or more processors in a multi-processing arrangement may also be employed to execute the sequences of instructions contained in main hard disk memory 807. In alternative embodiments, hard-wired circuitry may be used in place of or in combination with software instructions. Thus, embodiments are not limited to any specific combination of hardware circuitry and software.

As stated above, the system 801 includes at least one computer readable medium or memory programmed according to the teachings of the invention and for storing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 801, for driving a device or devices for implementing the invention and performing the methods described in FIGS. 6-9, and for enabling the computer system 801 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium or media that participate in providing instructions to processor 803 for execution. A computer readable medium may take many forms, including but not limited to, non-volatile media, volatile media, and transmission media. Non-volatile media includes, for example, optical, magnetic disks, and magneto-optical disks, such as hard disk 807 and/or removable media drive 808. Transmission media includes coaxial cables, copper wire and fiber optics, including the wires that comprise bus 802. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 803 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 801 may receive the data on the telephone line and use an infrared transmitter to convert the data to an infrared signal. An infrared detector coupled to bus 802 can receive the data carried in the infrared signal and place the data on bus 802. Bus 802 carries the data to main hard disk memory 807, from which processor 803 retrieves and executes the instructions. The instructions received by main hard disk memory 807 may optionally be stored on a removable media storage device 808 either before or after execution by processor 803.

Computer system 801 also includes a communication interface 813 coupled to bus 802. As described previously, communication interface 813 can itself form a promotion and/or promotion/address output device 634 and 644 when an electronic promotion and/or address data is communicated electronically to another device such as a computer, cash register, credit-card billing device, coupon printer, etc. Such electronic promotions can include, for example, electronic codes automatically transmitted to the register of a vendor, electronic data describing an advertisement to a consumer's personal computer, or deductions from a customer's account upon purchase or order of a product. Communication interface 813 provides a two-way data communication coupling to a communications network 816 that is connected to a local network 815. For example, communication interface 813 may be a network interface card to attach to any packet switched local area network (LAN). As another example, communication interface 813 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 813 sends and receives electrical, electromagnetic or optical signals that carry digital data streams representing various types of information.

Communications network 816 typically provides data communication through one or more networks to other data devices. For example, communications network 816 may provide a connection to another computer (not shown) through local network 815 (e.g., a LAN) or through equipment operated by a service provider, which provides communication services through a communications network 816. Communications network 816 can form network 620 of FIGS. 1 and 2. According to one embodiment, computer 801 forms an interaction site 630 while central database system 610 is formed by another computer 801. In some embodiments, local network 815 and communications network 816 preferably use electrical, electromagnetic, or optical signals that carry digital data streams. The signals through the various networks and the signals on network link 814 and through communication interface 813, which carry the digital data to and from computer system 801, are exemplary forms of carrier waves transporting the information. Computer system 801 can transmit notifications and receive data, including program code, through the network(s), network link 814 and communication interface 813.

Obviously, numerous modifications and variations of the present invention are possible in light of the above teachings. It is therefore to be understood that within the scope of the appended claims, the invention may be practiced otherwise than as specifically described herein.

1. A computer-implemented method comprising steps of:
receiving identification information from a consumer;
identifying, based upon said received identification information, one or more parameters related to promotions received by said consumer; and
determining a time at which a promotion is to be provided based upon said identified one or more parameters related to promotions received by said consumer.

2. The method according to claim 1, wherein said one or more parameters related to said promotions received by said consumer relate to a packaging of said received promotions received by said consumer.

3. The method according to claim 1, wherein said one or more parameters related to said promotions received by said consumer relate to a time at which said promotions received were received by said consumer.

4. The method according to claim 1, wherein said one or more parameters related to said promotions received by said consumer relate to a product class of said promotions received by said consumer.

5. The method according to claim 1, wherein said one or more parameters related to said promotions received by said consumer relate to a product industry of said promotions received by said consumer.

6. The method according to claim 1, wherein said one or more parameters related to said promotions received by said consumer relate to a location where said promotions received can be exercised by said consumer.

7. The method according to claim 1, wherein said one or more parameters related to said promotions received by said consumer relate to a value of said promotions received.

8. The method according to claim 1, wherein said one or more parameters related to promotions received by said consumer relate to a validity date of said promotions received.

9. The method according to claim 1, wherein said one or more parameters related to said promotions received by said consumer relate to a provision method of said promotions received.

10. The method according to claim 1, wherein said one or more parameters related to said promotions received by said consumer relate to a other purchases necessary to exercise said promotions received.

11. The method according to claim 1, wherein said one or more parameters related to said promotions received by said consumer relate to a nature of said promotions received.

12. The method according to claim 1, wherein said one or more parameters related to said promotions received by said consumer relate to a promoter who is the source of said promotions received.

13. The method according to claim 1, wherein said step of identifying one or more parameters comprises determining if said consumer is appropriate for said promotion, said promotion being predetermined.

14. The method according to claim 1, further comprising a step of providing said promotion at said determined time to said identified consumer.

15. The method according to claim 1, further comprising a step of using said received identification information to identify said consumer.

16. The method according to claim 1, further comprising a step of selecting a targeted promotion from a plurality of potential promotions based upon said one or more characteristics of said consumer, said determined time being for said targeted promotion.

17. The method according to claim 16, wherein said step of selecting said targeted promotion comprises matching said one or more characteristics of said consumer to a desired consumer profile.

18. The method according to claim 17, wherein said desired consumer profile originates from a promoter.

19. The method according to claim 1, further comprising a step of receiving a predetermined promotion from a promoter, said determined time being for said predetermined promotion.

20. The method according to claim 1, wherein said step of determining said time at which said promotion is to be provided comprises determining a number of promotions recently received by said consumer.

21. The method according to claim 20, wherein said number of promotions recently received by said consumer comprising promotions in a particular industry recently received by said consumer.

22. The method according to claim 20, wherein said number of promotions recently received by said consumer comprising promotions exercisable at a particular location recently received by said consumer.

23. The method according to claim 1, wherein said step of determining said time at which said promotion is to be provided comprises determining a value of said promotions recently received by said consumer.

24. The method according to claim 1, wherein said step of determining said time at which said promotion is to be provided comprises determining an importance of said provision of said promotion to a promoter.

25. The method according to claim 24, further comprising charging a promoter according to said importance of said provision of said promotion.

26. The method according to claim 1, wherein said step of determining said time at which said promotion is to be provided comprises determining at least one of a demographic and a purchase history characteristic of said consumer.

27. The method according to claim 1, wherein said step of determining said time at which said promotion is to be provided comprises:
determining promotions recently received by said consumer;
determining at least one of a demographic and a purchase history characteristic of said consumer;
determining an importance of said provision of said promotion to a promoter; and
fusing said determined promotions recently received, said at least one of a demographic and a purchase history characteristic, and said importance of said provision into one parameter related to said time at which said promotion is to be provided.

28. A system, comprising:
means for receiving identification information from a consumer;
means for identifying one or more parameters related to promotions received by said consumer based upon said identification information received by said means for receiving; and
means for determining a time at which a promotion is to be provided based upon said one or more parameters related to promotions received by said consumer, said one or more parameters identified by said means for identifying.

29. The system according to claim 28, wherein said one or more parameters of related to promotions received by said consumer comprising at least one of a timing, an industry, a class, a type, a packaging, a validity date, a valid location, other products that must be purchased to exercise, and a value of said promotions received by said consumer.

30. The system according to claim 28, further comprising means for providing said promotion at said time determined by said means for determining to said consumer identified by said means for identifying.

31. The system according to claim 28, further comprising means for selecting a targeted promotion from a plurality of potential promotions based upon said one or more characteristics of said consumer, said time determined by said means for determining being for said targeted promotion

32. The system according to claim 28, further comprising means for receiving a predetermined promotion from a promoter, said time determined by said means for determining being for said predetermined promotion.

33. A system, comprising:
a consumer identification information receiver configured to receive consumer identification information;
a consumer identification record configured to contain stored consumer identification information;
a consumer characteristic record configured to contain a record of characteristics of said consumer;
a promotion output device configured to output a targeted promotion at a promotion time based at least in part based upon said record of characteristics of said consumer; and
a processor configured to use said received consumer identification information to identify a consumer using said stored consumer identification information, and moreover to determine said promotion time at least in part based upon said record of characteristics of said consumer contained in said consumer characteristic record.

34. The system according to claim 33, wherein:
said promotion output device comprises a network interface; and
said promotion comprises an electronic signal.

35. The system according to claim 33, wherein said consumer characteristic record comprises:
a received promotions record configured to contain a record related to received promotions received by said consumer.

36. The system according to claim 35, wherein said received promotions record comprises a received promotion value record.

37. The system according to claim 35, wherein said received promotions record comprises a received promotion validity date record.

38. The system according to claim 35, wherein said received promotions record comprises a received promotion valid location record.

39. The system according to claim 35, wherein said received promotions record comprises a received promotion product class record.

40. The system according to claim 35, wherein said received promotions record comprises a received promotion industry record.

41. The system according to claim 35, wherein said received promotions record comprises a received promotion provision method record.

42. The system according to claim 35, wherein said received promotions record comprises a received promotion packaging record.

43. The system according to claim 35, wherein said received promotions record comprises a received promotion time of receipt record.

44. The system according to claim 33, wherein said processor is further configured to select said targeted promotion from a plurality of potential promotions based upon said one or more characteristics of said consumer.

45. The system according to claim 33, further comprising a promotion receiver configured to receive a predetermined promotion from a promoter, said promotion time determined by said processor being for said predetermined promotion.

46. A computer readable medium containing program instructions for execution on a computer system, which when executed by the computer system, cause the computer system to perform the method recited in any one of claims 1 to 27.
